(19) United States
(12) Patent Application Publication
(10) Pub. No.: US 2014/0304804 A1
(43) Pub. Date: Oct. 9, 2014

(54) ON-PREMISE CLOUD APPLIANCE

(71) Applicant: Epsilon Technology Solutions, Inc., Weaverville, NC (US)

(72) Inventors: Jason Albert Daniel Lee, Candler, NC (US); Eric Scott Oelschlaeger, Asheville, NC (US); Peter Reed Penzell, Annapolis, MD (US)

(73) Assignee: Epsilon Technology Solutions, Inc, Weaverville, NC (US)

(21) Appl. No.: 14/230,445

(22) Filed: Mar. 31, 2014

Related U.S. Application Data
(60) Provisional application No. 61/808,071, filed on Apr. 3, 2013.

(51) Int. Cl. H04L 29/06; G06F 9/455

(52) U.S. Cl. CPC H04L 63/0272; G06F 9/45533
USPC 726/15; 726/11

(57) ABSTRACT

A standalone onsite appliance designed to connect a local network and telephony infrastructure to a hosted cloud environment. The appliance acts as an extension of the cloud by creating a bridge into the local network and providing each local user a portion of the cloud infrastructure. The appliance integrates local and wide-area networking, security services, Voice over IP (VoIP) services, and a virtualized server environment. In addition, the appliance provides offline access to otherwise cloud hosted infrastructure, data, and serves as a failover solution in the event of a loss of Internet connectivity.

### CLAIM OF PRIORITY

This application claims priority to U.S. Provisional Application No. 61/808,071, filed on Apr. 3, 2013, the contents of which are incorporated herein by reference.

### BACKGROUND

The present invention relates to the field of computer technology. More specifically, the present invention relates to the fields of cloud computing and “Infrastructure as a Service” (IaaS) for cloud computing.

According to the National Institute of Standards and Technology (NIST), “cloud computing” is defined as “a model for enabling ubiquitous, convenient, on-demand network access to a shared pool of configurable computing resources (e.g. networks, servers, storage, applications, and services) that can be rapidly provisioned and released with minimal management effort or service provider interaction.” NIST defines Infrastructure as a Service as “the capability provided to the consumer [. . . ] to provision processing, storage, networks, and other fundamental computing resources where the consumer is able to deploy and run arbitrary software, which can include operating systems and applications. The consumer does not manage or control the underlying cloud infrastructure but has control over operating systems, storage, and deployed applications; and possibly limited control of select networking components (e.g., host firewalls).”

While there are a large number of cloud computing providers in the marketplace, and there are Infrastructure as a Service providers that can design solutions to connect a business to cloud computing, many organizations are financially unable to architect the implementation of cloud infrastructure services themselves or hire an outside consultant to design a cloud-based infrastructure from the ground up. There is, therefore, a need and desire for a better mechanism for providing a suitable infrastructure and easy access to advanced cloud computing services

Additionally, many cloud-based products contain proprietary elements that pose barriers to current applications services or future upgrade and expansion efforts. As such, there is a need and desire for a cloud-based solution without proprietary roadblocks and that is easy to upgrade and/or expand when needed.

### BRIEF DESCRIPTION OF THE DRAWINGS

FIG. 1 is a schematic view of an onsite appliance, constructed in accordance with an example embodiment disclosed herein, in relation to the cloud infrastructure and the private branch exchange.

FIG. 2 illustrates the internal components of the on-site appliance constructed in accordance with an example embodiment disclosed herein.

### DETAILED DESCRIPTION OF SEVERAL EMBODIMENTS

Embodiments of the present invention include an “onsite” appliance/device that is designed to connect a business server and telephony infrastructure to a hosted cloud environment. The onsite appliance serves as part of a cloud technology solution, developed to address the need of providing easy accessibility to advanced cloud technologies and services to a wide range of local users. The disclosed appliance acts as an extension of the cloud by creating a bridge into a local network and providing each local user a portion of the private cloud infrastructure. As will become apparent, the appliance integrates local and wide-area networking, security services, Voice over IP services (VoIP), and a virtualized server environment. In addition, the appliance provides offline access to otherwise cloud-hosted infrastructure and data, and serves as a failover solution in the event of Internet connectivity loss.

In essence, the appliance disclosed herein provides a standalone “cloud in a box” apparatus that is ready for “plug and play” operation at the local site/premises. As will be discussed below in more detail, the disclosed onsite appliance includes, but is not limited to, networking accessories and server hardware that provide an instant and secure connection to the Internet and to an offsite cloud server. The disclosed appliance provides an infrastructure that interfaces users of a local or other network to cloud-based services in an easy and efficient manner. Hereinafter, the installation site will be referred to as the “local premises” and the typical users of the local network will be referred to as “local users.” By standardizing and producing a replicable business infrastructure, the onsite appliance allows for rapid adoption of cloud-based computing services without the substantial engineering, implementation efforts, hassle and costs that traditionally accompany an Infrastructure as a Service deployment.

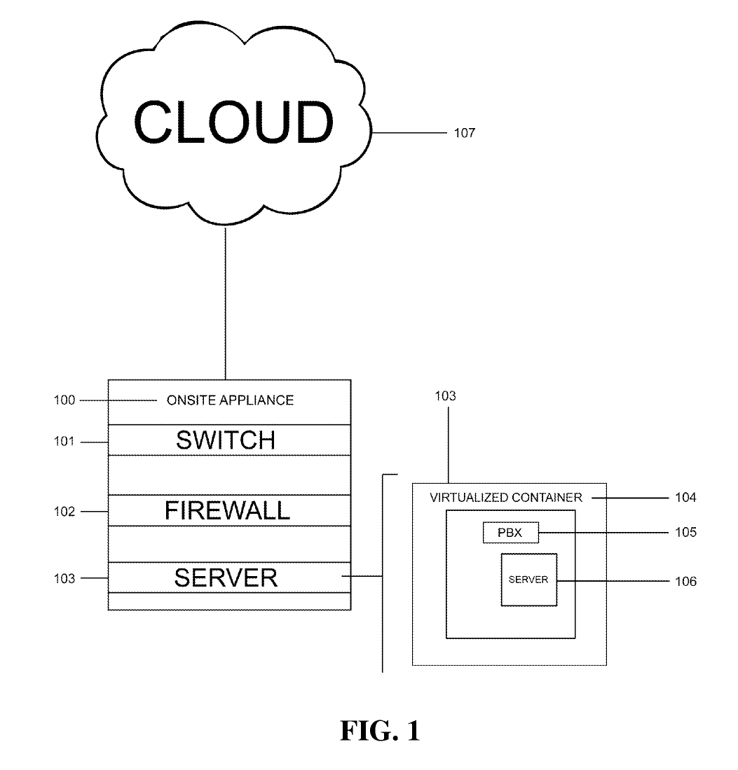

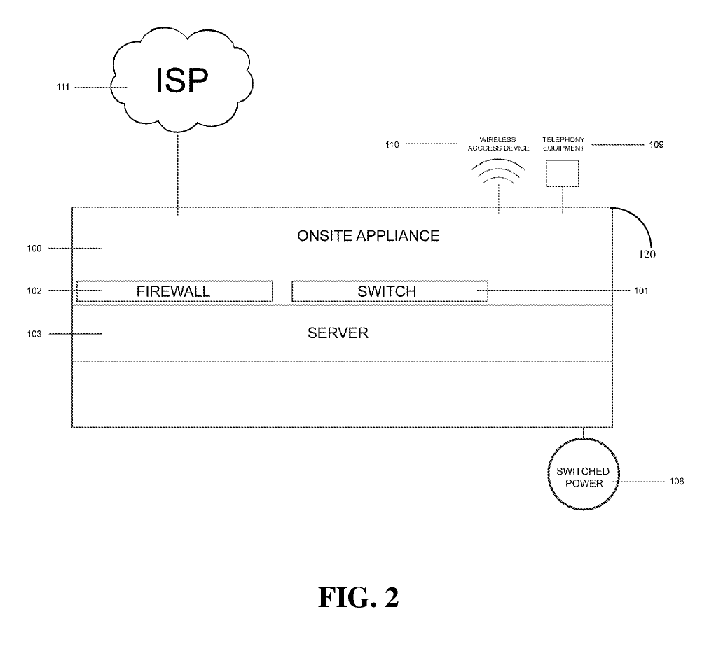

Referring to FIG. 1, a standalone onsite appliance 100 constructed in accordance with the disclosed principles is shown as being connected to a cloud network 107. Referring also to FIG. 2, the appliance 100 may be housed in a server cage or rack 120. The server cage/rack 120 houses a switch 101, firewall 102 and a server 103. An Internet Service Provider (ISP) 111 connects to the appliance 100 through the firewall 102 to provide access to and from the cloud network 107. The connection to the ISP 111 could be through an Ethernet or other wired/wireless network connection that would normally be used to connect to the local network. For example, the device required to connect to the ISP 111 could be a cable modem, router, or other appliance that provides direct connection to the Internet. Additionally, the device could be required to support a “bridge mode” where Network Address Translation (NAT) is disabled. Communications between the appliance 100, ISP 111 and cloud network 107 should be through TCP/IP or other data packet switching protocol suitable for Internet communications.

The switch 101 allows wireless access devices 110 and telephony devices 109 to connect to the appliance 100. Switched power 108 is the preferred mechanism used to power-up the appliance 100, although it should be appreciated that any powering mechanism (e.g., battery) could be used. The appliance 100 is installed at the local premises by connecting it to the ISP 111, telephony equipment 109 and/or a wireless access device 110.

The switch 101 is an intermediary device that will interconnect all of the onsite appliance components together as well as providing connectivity to, but not limited to, wireless devices, VoIP telephony devices, and the current state local network infrastructure. The switch 101 has an uplink Ethernet network cable connected to the network security device (i.e., firewall 102). One example of a suitable switch 101 is the 5-port Gigabit Ethernet Switch (model GS605) sold by Netgear®. It should be appreciated that this is only one example of a switch 101 that can be used in the appliance 100 and that other switches with the above-noted requirements can be used.

The network security device/firewall 102 provides a secure tunnel between the local premises' network with the cloud hosted infrastructure and the cloud resource domain for connectivity to the server's 103 resource network interface. The firewall 102 will also provide the first line of defense for security threats and attacks to local networks and the onsite appliance 100 itself. The firewall 102 will also serve as the edge router to the local network by providing network routing services. The firewall 102 will also provide a gateway to the VoIP services and may also need all appropriate ports opened in the firewall to accommodate the VoIP services and public facing services. One example of a suitable firewall 102 is the SonicWALL TZ 205 Network Security Appliance. It should be appreciated that this is only one example of a security device/firewall 102 that can be used in the appliance 100 and that other security devices with the above-noted requirements can be used.

Once installed and connected to the ISP 111, the appliance 100 dynamically consumes any of the local premises' current infrastructure as prescribed and provisions local site services to enhance network and systems operations. For example, an administrator can provision one virtual server that will run Microsoft® System Center (MSSC) and Level Platforms' “Onsite Manager” (from the Managed Workplace® product) prior to the onsite implementation of appliance 100. These applications are used to identify the local on-premise systems and architecture to be consumed. Once assets have been identified, the administrator can use MSSC to run physical-to-virtual conversions of the local user's equipment. These virtualized assets may also be migrated from the appliance 100 to an associated datacenter for subsequent use. Virtual machines will be created as necessary for e.g., local file systems, domain controllers, or required applications services. It should be appreciated that other applications can be used to identify the local infrastructure assets and/or to run the physical-to-virtual conversions. Examples of these applications include Enable, Ipswitch, Inc.'s WhatsUp Gold, and VMware®. It should be appreciated that these are examples of applications that could be used by the appliance 100 and that other applications or products could be used if desired.

The appliance 100 will provide primary voice and data communication services and will ensure system redundancy. The appliance 100 provides system redundancy by virtualizing a redundant domain controller, file system, PBX, and any additional applications services. The server 103 will act as a hypervisor, or virtual machine manager, creating, running and managing a plurality of virtual machines or containers 104. In a desired embodiment, there are as many virtual machines 104 as there are local users of the local premises' network. The appliance 100 is pre-configured, based on the specific needs of the local network and its users (i.e., number of users, types of software applications, and number of virtual machines). As is known in the art, a hypervisor allows multiple operating systems to share a single hardware host. Each operating system appears to have the host's processor, memory, and other resources all to itself. However, the hypervisor is actually controlling the host processor and its resources, allocating what is needed to each operating system in turn and making sure that the virtual machines cannot disrupt each other.

In one embodiment, the server 103 will run a Microsoft® Windows Server® operating system having hypervisor services. The hypervisor platform provides the ability to run any operating system as a virtual machine 104 of the appliance 100 and provides on-demand scalability and portability due to the hardware agnostic nature of virtualization. It should be appreciated that any software could be used by the server 103 to provide for the creation, running and managing of virtual machines 104. For example, the server software could include VMware® or CITRIX virtual machine management software. It should be appreciated that these are examples of virtual machine management software/applications that can be used by the server 103 and that other software/applications meeting the above requirements could be used. The server 103 can be joined to the cloud infrastructure's resource domain for remote management and control; in one embodiment, only the hypervisor role need be installed on the server 103 to achieve the functionality described herein.

In one embodiment, the server 103 will be plugged into the switch 101 via at least one Ethernet network cable. The number of network cables required will be dependent on the physical server itself, although at least two network interface ports may be provided for connectivity to the switch 101. In one embodiment, the server 103 could be a server provided by AMBX Servers, which is built to meet the local premise's requirements and specifications. It should be appreciated that this is only one example of a suitable server 103 that can be used in the appliance 100 and that other servers meeting the above-noted requirements and specifications can be used. A first network interface port may allow the segregation of management traffic between the physical server 103 and the cloud infrastructure's resource domain to allow for manipulation and creation of virtual machines, and physical machine to virtual machine conversions. A second network interface port may be dedicated to data/voice traffic between the virtual machines running on the hypervisor and any local end user accessing the services provided by these virtual machines. This second physical interface may be created into a virtual switch by the hypervisor role, which may be used by multiple virtual machines for IP based network connectivity.

Each virtual machine 104 is configured as having its own PBX function 105 and onsite server 106. The PBX function 105 provides the machine 104 with VoIP functionality allowing the user of that particular virtual machine to make and receive phone calls via the Internet. The PBX function 105 may be driven by PBX/communications software such as e.g., the open source software Asterisk®. In addition, an analog telecommunications card can be added to the onsite appliance 100 if it is desired to connect the appliance 100 to analog telephone lines. Moreover, cellular data connections can be used when properly equipped firewalls and cellular data connections are also used. This service can be provided by a provider of SIP trunking services such as e.g., RingFree™. The onsite server 106 may include cache functionality and domain services (e.g., Microsoft® Active Directory® domain services) to provide secure, structured, and hierarchical data storage. Data flows from the cloud network 107 into the appliance 100. The data is also run through one of the virtual containers 104 to access the PBX function 105 using VoIP functionality and/or to an onsite server 106 for other processing. It should be appreciated that other third party SIP compliant telephones and telephone systems (e.g., CISCO, SHORETEL, AVAYA) that are SIP compliant can be used to interchange or interconnect as necessary by the administrator of the local premises.

Once the appliance 100 is configured as set forth above and the virtual machines 104 are up and running, local users may have access to the cloud-based resources and services 107. For example, local users may have access to cloud-based storage and common applications such as e.g., Microsoft® Windows Server®, Microsoft® Exchange Server® (e.g., for email and calendar functionality), Microsoft® Office 365® (e.g., for word processing, spreadsheets, and presentation functionality), Microsoft® Sharepoint®, database applications, and IP-based telephony. The appliance 100 may give each local user the ability to locally access all network resources, such as e.g., file and print services, to keep access speeds high, while retaining cloud-based failover (discussed below). As applications and services are deployed into the cloud network 107, the server 103 may provide real time monitoring, alerting and reporting to ensure the health and performance of business critical systems. This can be accomplished, in one example embodiment, by having the server 103 run a managed services application such as e.g., Level Platforms' “Managed Services” application (from the Managed Workplace® product). It should be appreciated that patches and other fixes to any local or cloud-based application can be made through the same managed system application. Thus, the appliance 100 does not have to be replaced when patches, fixes, version updates or new software applications are needed.

In one embodiment, the appliance 100 disclosed herein diminishes the immense load that traditional cloud-based architectures place on the ISP 111 by dynamically caching data in the server 103. For example, the onsite appliance 100 provides local access to file systems and domain services by locally providing replicated copies for local user access. Utilities such as e.g., BranchCache™, Microsoft® DFS or DFS-R could be used to retain local performance deliverables as deemed necessary by the local users. Thus, the onsite appliance 100 is also beneficial to the ISP 111 and cloud network 107. The appliance 100 disclosed herein may provide load balancing to diminish the load on the ISP 107 by using services provided by the local onsite appliance 100 first, before accessing failover cloud services. In addition, the data cache provides local data access in the event of an Internet outage, and also preserves inter-office calling functionality and emergency 911 services. Thus, the onsite appliance 100 is unique in that it provides a failover connection (i.e., “offline functionality”) to all network services in the event of an Internet outage. Additional ISP connections can be added for load balancing and failover capabilities. Moreover, analog or other tertiary connections can be used to provide telephonic services for failover and continuity of service of the PBX function 104 (as described above).

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

What is claimed is:

1. A standalone network appliance comprising:
a housing;
a network security device within the housing and adapted to be connected to the Internet;
a network switching device within the housing and adapted to be connected to at least one telephony device and the network security device; and
a server within the housing and being connected to the network security device, said server being adapted to communicate with a cloud-based network through the network security device, said server being further adapted to configure and manage at least one virtual machine capable of providing a user of said virtual machine with data and telephony services using the cloud-based network.

2. The standalone network appliance of claim 1, wherein said switch is further adapted to communicate with a wireless access device.

3. The standalone network appliance of claim 1, wherein the telephony service comprises a Voice over IP service.

4. The standalone network appliance of claim 1, wherein each virtual machine comprises an onsite server having at least one of data cache and data storage functionality.

5. The standalone network appliance of claim 4, wherein each virtual machine further comprises a PBX function with Voice over IP functionality to allow the user of said virtual machine to make and receive phone calls via the Internet.

6. The standalone network appliance of claim 1, wherein the network security device is a firewall device.

7. The standalone network appliance of claim 1, wherein the server is further adapted to perform load balancing to manage traffic between the cloud-based network and the at least one virtual machine.

8. The standalone network appliance of claim 1, wherein the server is further adapted to provide offline access to data and services associated with the cloud-based network.

9. The standalone network appliance of claim 1, wherein data from the at least one virtual machine is backed-up to the cloud-based network.

10. A standalone network appliance comprising:
a network security device adapted to be connected to the Internet;
a network switching device adapted to be connected to at least one telephony device and the network security device;
a server connected to the network security device and being adapted to communicate with a cloud-based network through the network security device; and
a plurality of virtual machines running on said server, each virtual machine being capable of providing a user of said virtual machine with access to services provided by the cloud-based network, wherein at least one of the services provided by the cloud-based network comprises a digital telephony service.

11. The standalone network appliance of claim 10, wherein the digital telephony service comprises a Voice over IP service.

12. The standalone network appliance of claim 10, wherein the digital telephony service comprises a cellular telephone service.

13. The standalone network appliance of claim 10, wherein each virtual machine comprises an onsite server having at least one of data cache and data storage functionality.

14. The standalone network appliance of claim 13, wherein each virtual machine further comprises a PBX function with Voice over IP functionality to allow the user of said virtual machine to make and receive phone calls via the Internet.

15. The standalone network appliance of claim 10, wherein the network security device is a firewall device.

16. The standalone network appliance of claim 10, wherein the server is further adapted to perform load balancing to manage traffic between the cloud-based network and the plurality of virtual machines.

17. The standalone network appliance of claim 10, wherein the server is further adapted to provide offline access to data and services associated with the cloud-based network.

18. The standalone network appliance of claim 10, wherein data from the plurality of virtual machine is backed-up to the cloud-based network.

19. The standalone network appliance of claim 10, wherein said server configures and manages the plurality of virtual machines.

20. A method for joining a local network to an offsite cloud server, said method comprising:
installing a standalone network appliance, said appliance comprising:
a network security device adapted to be connected to the offsite cloud server;
a network switching device adapted to be connected to at least one telephony device and the network security device;
a server connected to the network security device and being adapted to communicate with a cloud-based network through the network security device; and
a plurality of virtual machines running on said server, each virtual machine being capable of providing a user of said virtual machine with access to services provided by the cloud-based network, wherein at least one of the services provided by the cloud-based network comprises a digital telephony service.

21. The method of claim 20, wherein the standalone network appliance is connected to the Internet.

22. The method of claim 20, wherein the standalone network appliance is joined to an offsite cloud server via a Virtual Private Network (VPN) connection.

23. The method of claim 20, wherein the local network is virtualized and joined to the standalone network appliance.

24. The method of claim 24, wherein data from the virtualized local network is replicated to the standalone network appliance.

25. The method of claim 20, wherein the standalone network appliance is replicated with the offsite cloud server.

26. The method of claim 20, wherein the standalone network appliance provides offline access to data and services associated with the cloud-based network.
